(19) United States
(12) Patent Application Publication
(10) Pub. No.: US 2024/0151907 A1
(43) Pub. Date: May 9, 2024

(54) FIBER OPTIC COMPONENT

(71) Applicant: FiberBridge Photonics GmbH, Hannover (DE)

(72) Inventor: Thomas THEEG, Seelze (DE)

(73) Assignee: FiberBridge Photonics GmbH, Hannover (DE)

(21) Appl. No.: 18/505,374

(22) Filed: Nov. 9, 2023

(30) Foreign Application Priority Data
Nov. 9, 2022 (DE) 102022129645.8

(51) Int. Cl. G02B 6/26; G02B 6/32

(52) U.S. Cl. CPC G02B 6/262; G02B 6/322

(57) ABSTRACT

Fiber optical component (1) comprising a plurality of optical fibers (10) each having at least, preferably exactly, one core of glass, preferably made of quartz glass, which is designed in each case to guide a signal light radiation (A), with at least, preferably exactly, one first optical element (11) made of glass, preferably made of quartz glass, which is connected to an inlet surface (11a) with in each case one open end of the cores of the optical fibers (10), preferably further connected to an open end of a cladding of the optical fibers (10) substantially enclosing the core, and designed to receive the signal light radiations (A) from the open ends of the cores of the optical fibers (10) and to emit them to the outside via at least one outlet surface (11b), with at least, preferably exactly, a second optical element (12) made of glass, preferably quartz glass, per optical fiber (10), which is designed and arranged at a distance relative to the first optical element (11) along the direction of propagation of the signal light beams (A), to receive the signal light radiation (A) of at least, preferably exactly, one of the optical fibers (11) at an inlet surface (12a) from the first optical element (11) and to emit it to the outside via at least one outlet surface (12b), and with a carrier (14) which positions the second optical elements (12) at least along the direction of propagation of the signal light radiations (A), preferably and transversely to the direction of propagation of the signal light radiations (A), relative to the first optical element (11), wherein the carrier (14) has glass, preferably quartz glass, preferably consists of glass, preferably quartz glass.

The present invention relates to a fiber optical component in accordance with claim 1 and claim 9.

Today, optical fibers are used in many different technical areas. Technical and particularly highly technical applications include the use of optical fibers for light transmission. For example, optical fibers are used for data transmission by means of light; in this case, the optical fibers can also be referred to as optical waveguides or passive optical fibers. Optical fibers are also used in medicine, for example for lighting and for generating images, for example in microscopes, inspection cameras and endoscopes. Further, optical fibers are used in sensors, which can then be referred to as fiber optic sensors.

Another area of application for optical fibers is laser technology. Here, the laser radiation can be guided as signal light radiation by means of a passive optical fiber from a laser radiation source as a signal light source or as a signal light radiation source to a processing point in order to perform cutting or welding, for example, in material processing or in medicine. The laser beam can also be fed to a sample as laser radiation in this manner, for example in measurement technology, microscopy or spectroscopy. Passive optical fibers can be used to conduct a laser beam in applications such as mechanical engineering, telecommunications, medical technology and sensor technology.

Optical fibers can also be used to generate or amplify laser light and are referred to as active optical fibers. Fiber lasers for generating laser light or fiber amplifiers for amplifying laser light have a doped fiber core (see below) in some portions, which forms the active medium of the fiber laser or the fiber amplifier, i.e. its active optical fiber. Common doping elements of the laser-active fiber core are particularly neodymium, ytterbium, erbium, thulium and holmium. Fiber lasers or fiber amplifiers are used in industry for ultrashort pulse laser systems (for example at a wavelength of approx. 1 μm), in measurement technology (for example for LIDAR measurements—laser detection and ranging), in medical applications (for example at a wavelength of approx. 2 μm) or in space applications (for example at a wavelength of approx. 1.5 μm).

Optical fibers, which are used to amplify signal light such as laser radiation in fiber amplifiers or to generate laser radiation in fiber lasers, usually have a fiber core, which consists of pure glass such as pure quartz glass and, in the case of passive optical fibers, is often doped with germanium; active optical fibers are usually doped as described above. In certain cases, the fiber cladding can also be doped; this applies to both passive and active optical fibers. Depending on the size and numerical aperture of the fiber core, a distinction can be made between single-mode and multi-mode optical fibers. In addition, the fiber core can still have polarization-maintaining properties for the light and can therefore be referred to as polarization-maintaining optical fibers (PM). They can also be photonic crystal optical fibers and hollow-core optical fibers. Even if the main field of application is optical fibers, polymer fibers or fibers made of other materials, for example so-called soft glass fibers for the central IR area, can also be used for such applications.

The fiber core is usually surrounded radially from the outside by at least one fiber cladding, which is usually closed in the circumferential direction and thus completely surrounds the fiber core, apart from the two open ends of the optical fiber. The fiber cladding is also usually made of quartz glass.

Both passive optical fibers and active optical fibers are usually surrounded by a fiber coating made of polymer, for example, comparable to the fiber cladding, which can then be assigned to the optical fiber. The fiber coating can serve to mechanically protect the glassy interior of the optical fiber and influence its optical characteristics. For optical fibers in which the light is guided exclusively in the fiber core (single-clad optical fibers), the fiber coating is usually primarily used for mechanical protection. Optical fibers that carry light in the fiber core and in the fiber cladding (double-clad optical fibers) are usually coated with a fiber coating to achieve mechanical and optical properties.

Two common cross-sectional shapes for the fiber cladding are cylindrical and octagonal. The octagonal shape for the fiber cladding is particularly used for active optical fibers.

Such optical fibers can be produced in long lengths and are usually available in rolls. The diameter of the fiber cladding usually varies between approx. 80 μm and approx. 1 mm. The larger fiber diameters in particular are often referred to in practice as rod-type fibers.

Four substantially passive fiber components are typically required for a fiber amplifier: a signal light radiation input as an interface for feeding in or for coupling in the signal light radiation to be amplified as input radiation from outside the fiber amplifier, a pump light coupler, which transports the pump light radiation almost loss-free from the pump light source into the cladding of the active optical fiber, a pump light trap, which absorbs unabsorbed pump light from the active optical fiber or removes it from the cladding of the optical fiber, and a signal light radiation output, which forms and/or guides the output radiation and thereby decouples it outside the fiber amplifier and makes it available. The signal light radiation output can also be referred to as a fiber outlet element or fiber outlet optics.

A fiber laser also usually uses a pump light coupler, an active optical fiber, a pump light trap and a signal light beam output. Since no signal light radiation is supplied from outside here, but the laser radiation is generated inside the fiber resonator between two reflectors or mirror elements, the signal light radiation input is not required.

In any case, an optical window with an anti-reflection coating on one side for the corresponding wavelengths or a lens for collimating the output radiation can serve as the signal light radiation output, the first optical element or the fiber outlet element. The first optical element or the fiber outlet optics can also be another optical fiber that guides the output radiation to an intended location. Such first optical elements are usually connected to the open end of the optical fiber, for example by welding, also known as splicing. This allows the signal light or the laser light to pass directly into the first optical element, for example as an optical window or as a lens, and from there to emerge outside, for example, the fiber amplifier or the fiber laser. By means of the optical window or lens, the beam of the signal light or laser light can be widened, i.e. its cross-section can be enlarged, thereby reducing its power density, which may be favorable or necessary for certain applications.

It is thus known to connect a single optical fiber to a single first optical element as described above. If a plurality of individual optical fibers, each of which is connected to a single first optical element, are to be used in combination with one another, these optical fibers together with their respective first optical element or together with their respective fiber outlet element must be arranged or positioned, at least substantially, transversely to the direction of propagation of the signal light radiation in a defined manner in order to achieve the desired common beam path of all signal light radiations of the optical fibers, usually parallel to one another. This is particularly true if the signal light beams are to be directed onto a common second optical element such as a common lens for collimating the output beams, also known as a collimator, or onto a respective microlens.

For this purpose, it is common practice to arrange the individual optical fibers together with their respective first optical element, particularly parallel to one another, on a common carrier or to have them held and positioned relative to one another by the carrier. Such a carrier can also be referred to as a rack, frame or housing. In each case, the optical fibers themselves or their respective first optical element are connected to the carrier and thus positioned relative to one another, at least substantially transverse to the direction of propagation of the signal light radiation. The individual first optical elements are usually inserted through openings in the carrier or a transverse carrier of the carrier and are thereby held and positioned, at least substantially, transverse to the direction of propagation of the signal light radiation or transverse to the longitudinal direction of extension of the optical fibers together with their respective first optical element. The optical fibers together with their respective first optical element can be held along the direction of propagation of the signal light radiation or its longitudinal direction of extension by creating a material connection between the carrier or between the transverse carrier and the respective first optical element by means of adhesive.

The disadvantage of this is that such carriers or transverse carriers are made of metal. Thus, heating of the carrier or its transverse carrier can cause the metallic material of the carrier or its transverse carrier to expand when the temperature increases or to contract or shrink when the temperature decreases, particularly transverse to the direction of propagation of the signal light radiation or transverse to the longitudinal direction of extension of the optical fibers together with their respective first optical element. Different forces can also arise locally due to temperature gradients at the connection points or at the bonding points. This increases the distances between the optical fibers together with their respective first optical element and thus also between the emerging signal light beams and thus changes or disturbs the alignment of the signal light beams to one another.

A further disadvantage is that the adhesive between the carrier or its transverse carrier and the respective first optical element can also be heated by signal light radiation and/or by external environmental influences. In addition, the adhesive can be gradually damaged by the absorption of signal light radiation and degrade its properties. If the absorption of signal light radiation is too strong, e.g. during the conversion of optics with high laser power, a joint with adhesive can be destroyed within seconds. Another major risk when using adhesives is the degradation of the adhesive's properties over long time scales. At high optical laser powers, this can also lead to safety-related problems. This can, at least in the long term, lead to a reduction in the adhesive force or the adhesive effect of the adhesive and thus allow displacement between the carrier or its transverse carrier and the respective first optical element both transversely to the direction of propagation of the signal light radiation or transversely to the longitudinal direction of extension of the optical fibers together with their respective first optical element and along the direction of propagation of the signal light radiation or along the longitudinal direction of extension of the optical fibers together with their respective first optical element.

In particular, the positioning transverse to the direction of propagation of the signal light radiation or transverse to the longitudinal direction of extension of the optical fibers together with their respective first optical element can be changed by a correspondingly increased degree of movement of the first optical elements relative to the through-openings of the carrier or its transverse carrier. The adhesive can also, at least in the long term, completely lose its adhesive strength or adhesive effect on the signal light radiation and thus the optical fibers together with their respective first optical element can detach from the carrier or its transverse carrier.

For many applications, for example in material processing or medical technology, it is relevant to use several laser beams in an arrangement that is as spatially compact as possible and, above all, thermally and mechanically highly stable at the point of use. This allows, for example, an incoherent or coherent combination of numerous laser beams to be realized. Depending on the target, the laser beams can be arranged in a one- or two-dimensional geometric arrangement.

If instead a plurality of optical fibers are combined together with a single first optical element or with a single fiber outlet element, this leads to additional effort to arrange and align the individual optical fibers to one another such that the respective signal light beams can be emitted and used as desired. This also represents a significant source of error during mounting, which can lead to a poor or even unusable end product.

WO 2020/254661 A1 describes a fiber outlet element with a plurality of optical fibers, each with at least one core which is designed to guide a signal light radiation, and with at least one optical element which is connected to one open end of each of the cores of the optical fibers and is designed to receive the signal light radiation from the open ends of the cores of the optical fibers and to emit it to the outside as outlet radiation via at least one outlet surface. The open ends of the cores of the optical fibers are each arranged with a penetration depth within the material of the optical element, wherein at least the material of the open ends of the cores of the optical fibers is fused to the material of the optical element.

This allows the arrangement or positioning and alignment of the individual optical fibers by means of a common single first optical element or by means of a single fiber outlet element.

However, if a second or further optical element such as a common lens or a respective microlens per optical fiber is also to be used in this case, the common first optical element or the common fiber outlet element must also be connected to the common second optical element or to the respective second optical element by means of a carrier or by means of a longitudinal carrier and/or a transverse carrier. Other optical elements in or on the carrier system can be lenses or lens systems of various types, optical filters, dichroics, optical wedge windows, prisms, protective windows or other optical elements, in each case for the individual beam or for the overall beam.

Such carriers or longitudinal carriers and/or transverse carriers are also made of metal. Thus, in this case, heating the carrier can also cause the metallic material of the carrier to expand, particularly transverse to the direction of propagation of the signal light radiation or transverse to the longitudinal direction of the optical fibers. If a plurality of second optical elements are held and positioned by means of the carrier or its transverse carrier, the heating of the carrier or its transverse carrier increases the distances between the individual second optical elements transverse to the direction of propagation of the signal light radiation, which changes or disturbs the alignment of the individual second optical elements relative to the optical fibers transverse to the direction of propagation of the signal light radiation.

Since adhesive is also used in this case for the connection of the first optical element and/or the second optical elements to the carrier, the heating also affects the durability of the adhesive in this case, as described above. Even when using alternative approaches for joining the optical elements and carriers, the problem of using different materials with different expansion coefficients remains. This may lead to stresses during heating and cooling behavior (environmental influences or signal light absorption) and thus possibly to a change in the optical properties of an optical system.

In any case, such heating of the respective metallic carrier and the adhesive is substantially caused by the signal light radiation itself during operation, i.e. when signal light radiation is present. Thus, both in the case of a plurality of individual first optical elements or a plurality of individual fiber outlet elements, each with one optical fiber, and in the case of a common first optical element with a plurality of optical fibers, such as the fiber outlet element of WO 2020/254661 A1, absorption losses of the signal light radiation can occur due to the propagation of the signal light radiation within the first optical element, since the material of the first optical element is usually not completely transparent and thus at least a small amount of the signal light radiation is absorbed as it passes through the first optical element. In addition, further reflections and scattering of the signal light radiation on the optics and possibly carriers lead to heating of the carriers and joints.

This can particularly be the case if optical powers of several hundred watts or several kilowatts are transported per signal light beam or if wavelengths are used that can in principle cause comparatively high absorption losses in the material of the first optical element.

Such heating of the respective metallic carrier and/or the adhesive can additionally or alternatively be caused by external circumstances, general conditions or environmental conditions.

U.S. Pat. No. 6,945,701 B2 relates to a multi-part fiber optic component and a manufacturing method.

U.S. Pat. No. 5,548,675 B1 relates to a multifiber connector, a method for the production thereof and a construction for connecting the multifiber connector to an optical device.

U.S. Pat. No. 6,442,306 B1 relates to a self-aligning fiber optic plug for N×M arrays.

U.S. Pat. No. 5,550,942 A relates to micromachined holes for glass fiber connections.

U.S. Pat. No. 5,671,311 A relates to a sealed multiposition fiber optic plug.

JP 2010 164 708 A relates to an optical fiber arrangement and a method for the production thereof.

JP 5 185 214 B2 relates to an optical fiber arrangement.

US 2003/0002818 A1 relates to a two-dimensional precision optical waveguide array.

JP 2004/252244 A relates to the provision of a fiber optic collimator array that can be assembled with high accuracy and at low cost. To this end, the fiber optic collimator array has an optical fiber collimator array arranged with a plurality of optical fibers in a determined direction, a microlens array arranged with a plurality of microlenses in a determined direction, and a spacer arranged between the array and the array and having a prescribed thickness. The peripheral parts of the substrates, which form the optical fiber collimator array or the microlens array, are provided with guide holes of cylindrical shape. Further, guide pins having outer diameter dimensions approximately equal to the bore diameter of the guide bores are inserted into the guide bores of the optical fiber collimator array and the microlens array, and thereby the optical fiber collimator array and the microlens array are aligned and fixed.

One object of the present invention is to provide a fiber optical component of the type described above, such that the positioning accuracy of the components of the fiber optical component relative to one another can be improved during operation. In terms of beam optics, a fiber optical component of the type described at the beginning is to be provided, which enables a more stable propagation of individual laser beams than previously known in an arrangement relative to one another during operation, wherein in the case of the use of beam combination techniques (coherent, spectral) the term “individual laser beam” can also comprise a possibly superimposed laser beam. In particular, the effects of heating of a carrier and/or joining points, particularly adhesives, and/or heating of the carrier and/or joining points, particularly adhesives, are to be reduced or avoided. Additionally or alternatively, the handling of the fiber optical component is to be improved. In particular, thermally induced mechanical forces on the connections between the components of the fiber optical component should be reduced or avoided. This should be possible in particular for the fiber outlet element of WO 2020/254661 A1. This should be as simple, cost-effective and/or space-saving as possible. At the very least, an alternative to known fiber optical components is to be created.

According to the invention, the object is achieved by the fiber optical components of the independent claims. Advantageous further developments are described in the subclaims.

Thus, the present invention relates to a fiber optical component. Such a fiber optical component can be any component of a fiber optical product or a fiber optical system which receives signal light radiations by means of optical fibers and transmits or outputs the signal light radiations via at least one further optical element. Accordingly, the fiber optical component according to the invention has a plurality of optical fibers each having at least, preferably exactly, one core of glass, preferably of quartz glass, each of which is designed to guide a signal light radiation. This allows the signal light beams to be fed to the fiber optical component according to the invention.

The fiber optical component according to the invention also has at least, preferably exactly, a first optical element made of glass, preferably of quartz glass, which is connected at an inlet surface to a respective open end of the cores of the optical fibers, preferably further to an open end of a cladding of the optical fibers substantially enclosing the core, and is designed to receive the signal light radiations from the open ends of the cores of the optical fibers and to emit them to the outside via at least one outlet surface. The first optical element can be an optical window, an optical lens, an optical beam splitter or an optical prism.

In any case, a connection, preferably by means of welding, can be made between the open ends of the optical fibers and the first optical element. This can be converted, for example, as in the fiber outlet element of WO 2020/254661 A1, such that preferably the open ends of the cores of the optical fibers, preferably further the open ends of claddings of the optical fibers substantially surrounding the cores, each with a penetration depth, preferably opposite an entrance surface of the optical element, is arranged within the material of the first optical element and at least the material of the open ends of the cores of the optical fibers, preferably further the material of the open ends of the claddings of the optical fibers, is fused with the material of the first optical element. Among other things, this can improve the mechanical connection between the optical fibers and the optical element.

The fiber optical component according to the invention further has at least, preferably exactly, one second optical element made of glass, preferably quartz glass, per optical fiber, which is designed and arranged at a distance relative to the first optical element along the direction of propagation of the signal light radiation in each case, in order to receive the signal light radiation of at least, preferably exactly, one of the optical fibers at an inlet surface from the first optical element and to emit it to the outside via at least one outlet surface. Thus, preferably exactly, a second optical element such as a microlens can be assigned to exactly one optical fiber or its signal light radiation in each case, such that the respective signal light radiation can emerge from the first optical element into the surrounding medium such as the ambient air, reach the respective second optical element and pass through the second optical element in order, for example, to be influenced and/or bundled with respect to the further direction of propagation of the respective signal light radiations. A microlens can be a lens with a diameter of 0.5 mm to a few millimeters.

However, it is also possible that a plurality of second optical elements, arranged one behind the other and/or side by side along the direction of propagation of the signal light radiation, pick up the signal light radiation of an optical fiber. Similarly, the signal light beams of several optical fibers could also be picked up by a common second optical element. This can increase the scope for design.

In any case, the “plurality of second optical elements” are to be understood functionally, such that a plurality of second optical elements can also be formed together by a common body in one piece, i.e. integrally, or in one piece, i.e. joined together, as will be explained in more detail below.

The fiber optical component according to the invention further has a carrier which positions the second optical elements at least along the direction of propagation of the signal light beams, preferably and transversely to the direction of propagation of the signal light beams, relative to the first optical element. This allows the second optical elements to be arranged and aligned relative to the first optical element and thus to the optical fibers. The carrier can also be referred to as a frame, a rack or housing. A carrier can be any structural element or any combination of structural elements of the fiber optical component that can fulfill the function of the carrier described above. This can also be done by only a portion of an element or by only portions of elements of the fiber optical component that can perform this function.

The carrier has glass, preferably quartz glass, and is preferably made of glass, preferably quartz glass. Thus, at least the portions or elements of the carrier which can fulfill the previously described function of the carrier are designed partially or completely of glass or quartz glass. This allows the corresponding material properties to be utilized, particularly with regard to comparatively low absorption and/or comparatively low heating, heat conduction and heat-related expansion on the part of the carrier.

The present invention is based on the realization that in the previous metallic carriers, frames, racks, housings and similar, which connect the optical fibers and optical elements in known fiber optical components to one another and thereby position them relative to one another, any heating, whether during operation or due to other external influences, can lead to expansion of the metallic material and thereby change or disturb the positioning of the elements relative to one another. For example, the positioning of optical fibers together with the first optical element can be displaced per optical fiber transverse to the direction of propagation of the signal light beams, so that, for example, a focusing effect of the second optical elements as microlenses can be impaired. In addition, thermal misalignment of the laser beams could significantly change the result of material processing, such as 3D printing with metal powder. The resulting superimposed optical power (with the best possible beam quality) could also be reduced in the event of misalignment of the individual laser beams in a coherent or spectral beam combination. If necessary, the signal light radiation can even be guided past the respective second optical element, such that the second optical element no longer has any effect on the signal light radiation and/or the housing is strongly heated, which could result in safety risks. The signal light radiation can also escape into the environment, which can also pose a safety risk.

According to the invention, the material properties of glass are therefore also to be used on the part of the carrier or the elements or portions thereof, which can have the negative effects described above on the positioning of the second optical elements and thus on the function of the fiber optical component due to heating. The carrier or the elements or portions thereof therefore have glass, so that when heated there is comparatively little expansion compared to the previous metallic carriers. This can be increased if the carrier or the elements or portions thereof are made entirely of glass. In any case, this effect can be further improved or increased by using quartz glass.

It is also advantageous here that by using glass or quartz glass as the material of the carrier or the elements or portions thereof, the same materials can be used there as for the optical fibers, first optical elements and second optical elements. In this manner, properties of the materials of the optical fibers, the first optical elements and the second optical elements can be transmitted, so to speak, to the carrier or the elements or portions thereof, such that a uniform optical and/or thermal behavior of the fiber optical component according to the invention can be achieved.

In particular, heating due to the absorption of signal light radiation can be equally reduced or avoided everywhere on the fiber optical component according to the invention. Residual and/or nevertheless occurring heating, for example due to external influences, can only produce a comparatively small expansion of the elements of the fiber optical component according to the invention. Further, the remaining expansion can occur everywhere on the fiber optical component according to the invention in a comparable or uniform manner, such that even in the event of thermally induced expansions of the optical fibers, the first optical elements, the second optical elements and the carrier or portions thereof, these components of the fiber optical component according to the invention are not changed relative to one another or are changed only negligibly in their positioning relative to one another.

In any case, this can improve the positioning accuracy of the components of the fiber optical component relative to one another during operation and, in particular, reduce or avoid the effects of heating of the carrier or the elements or portions thereof.

It is also advantageous that the carrier can also be used for handling, mounting, transporting and similar purposes of the fiber optical component according to the invention or can make this possible in the first place. In other words, the fiber optical component according to the invention can be gripped by a person directly or by means of auxiliary means on the carrier in order to be able to handle or transport the fiber optical component according to the invention without, however, touching the optical elements or damaging or breaking off the welded connection between the optical fibers and the first optical element. This can prevent damage to the fiber optical component according to the invention.

It is further advantageous that the carrier can be designed as a housing, i.e. as an at least substantially to completely closed enclosure, in order to enclose at least the area of the fiber optical component between the first optical element and the second optical element, such that external influences such as moisture, contamination, dust and similar can be kept away from there. This can keep such external influences away from the ray path of the signal light beams, at least in this area, and thus avoid corresponding interference.

In any case, a volume can be completely enclosed by the first optical element together with the carrier or with part of the carrier and the second optical element, which can be filled with ambient air, but also with another medium such as an inert gas, in order to influence the propagation behavior of the signal light beams. This applies accordingly to any further volume that may be present, which can be enclosed by the second optical element, the carrier or a further part of the carrier and a third optical element. In any case, this filling can be permanent, i.e. the volume can be filled with the medium and then sealed media-tight. Alternatively, however, it is also possible to have a through-flow during operation, for which corresponding inlets and outlets must be provided, through which the medium can be conveyed into the volume through the inlet and out of the volume through the outlet.

In accordance with an aspect of the invention, the carrier has a longitudinal carrier which positions the second optical elements relative to the first optical element along the direction of propagation of the signal light beams, and/or the carrier has a transverse carrier which positions the second optical elements relative to the first optical element transversely to the direction of propagation of the signal light beams. This allows the positioning in the corresponding spatial directions to be concretely converted.

In accordance with a further aspect of the invention, the material of the carrier, preferably the longitudinal carrier and/or the transverse carrier, is welded to the material of the second optical elements, preferably to an additional amount of glass, preferably transverse glass. This eliminates the need for adhesive, which could otherwise lead to a weak point in the positioning as described above. Other materials can also be avoided as connections, for the reasons mentioned above. Rather, by welding contact partners made of glass or quartz glass itself, other materials can also be dispensed with at the connection points, which could have other thermal properties and thus other or even thermally induced expansions.

This can preferably also be done by applying welding with glass or quartz glass to the connection points, e.g. with the laser, in order not to change the geometry of the connection partners such as the first optical element and carrier and/or second optical element and carrier, but instead to apply additional identical material to the connection points and thereby create a material connection to both connection partners. This can minimize the influence of the connection on the two connection partners.

In accordance with a further aspect of the invention, the carrier, preferably a transverse carrier of the carrier, receives the second optical elements facing away from the first optical element in such a manner that the signal light radiations penetrate the material of the carrier, preferably of the transverse carrier. In other words, the material of the carrier or the transverse carrier thereof is arranged in the ray path of the signal light beams between the first optical element and the second optical elements, such that the signal light beams penetrate the material of the carrier or the transverse carrier thereof before they penetrate into the respective second optical element. This can improve and simplify the connection between the second optical elements and the carrier or the transverse carrier thereof, as the second optical elements can be applied flat with their entry surface on the surface of the carrier or the transverse carrier thereof facing away from the first optical element, particularly by welding. This can ensure a secure hold, which can be produced comparatively easily.

In accordance with a further aspect of the invention, the carrier, preferably a transverse carrier of the carrier, has one through-opening per second optical element and the carrier, preferably the transverse carrier, receives the second optical elements facing away from the first optical element in such a manner that the signal light beams pass through the respective through-opening of the carrier, preferably of the transverse carrier. This means that the carrier or the transverse carrier thereof can be used to create a connection to the second optical elements, particularly at the edge, for example by welding, without the signal light beams penetrating the material of the carrier or the transverse carrier thereof. This prevents the material of the carrier or transverse carrier from influencing the signal light radiation. This can also prevent the material of the carrier or transverse carrier from heating up due to the signal light radiation. Nevertheless, the edge-side connection or welding can create a comparatively secure hold of the second optical elements on the carrier or on the transverse carrier thereof.

In accordance with a further aspect of the invention, the second optical elements are designed as a single piece or in one piece and the signal light rays penetrate the material of the single-piece or one-piece second optical elements directly. In other words, the individual optical elements are connected to one another transversely to the direction of propagation of the signal light radiation by their one-piece, i.e. integral, or one-piece, i.e. joined-together, formation, such that the second optical elements structurally form only one optical element, but are still to be regarded functionally as a plurality of individual optical elements. Due to the one-piece or one-piece design, there is no need for additional support from the carrier or a transverse carrier in this area. In this case, such a hold or positioning relative to the first optical element can, depending on the design, take place at the edge of the one-piece or one-piece second optical elements along the direction of propagation of the signal light beams and, if necessary, additionally along the direction of propagation of the signal light beams.

In accordance with a further aspect of the invention, the outlet surface of the first optical element, the inlet surface of the second optical element, the outlet surface of the second optical element and/or the carrier has an optical coating, preferably an optical anti-reflection coating, at least in sections, preferably over the entire surface. In particular, an optical anti-reflection coating on the outlet or inlet surface of the first and/or second optical element can reduce or minimize the reflected signal light radiation at the outlet or inlet surface (glass-air interface). The anti-reflective coating can preferably be designed or optimized for the wavelengths or wavelength range of the signal light radiation. This can reduce the level of interference radiation within the first or second optical element or the surrounding carrier. The arguments listed here for the anti-reflective coating also apply to all other optical elements and/or glass carrier materials.

In accordance with a further aspect of the invention, the carrier, preferably an optical fiber holder of the carrier, positions the optical fibers facing away from the inlet surface of the first optical element transversely to the direction of propagation of the signal light beams, loosely guided or fixedly connected.

The carrier can thus, in particular as a housing, further serve to guide and/or connect and/or hold the optical fibers relative to the first optical element and/or relative to further and/or all optical elements in order to hold and/or stabilize the optical fibers and thereby improve the handling, mounting, transport and similar of the fiber optical component according to the invention, particularly with regard to the outstanding optical fibers. This can further improve the previously described function of the carrier or extend it to the optical fibers.

For this purpose, it may be sufficient to perform one or more optical fibers loosely, i.e. unconnected, through the corresponding through-openings of the optical fiber holder of the carrier, which can be performed with radial contact or also without radial contact to the inner edge of the through-openings of the optical fiber holder of the carrier. In this manner, the area of the fiber optical component according to the invention, which is formed by the carrier together with its fiber optic holder and the first optical element, can be substantially to completely enclosed from the environment, particularly when the carrier is designed as a housing. The optical fibers could also be guided in the longitudinal direction and supported radially.

Additionally or alternatively, some or more optical fibers can be connected to the optical fiber holder of the carrier, which can be achieved in a force-locking manner by a suitable dimensioning of the exterior side of the optical fibers to the interior sides of the through-openings of the optical fiber holder of the carrier. Alternatively or additionally, a material-locking connection can be made, selectively, in portions or completely, between the exterior side of the optical fibers to the interior sides of the through-openings and or in front of and or behind the through-openings of the optical fiber holder of the carrier, particularly by welding with glass or preferably quartz glass, preferably with an additional amount of glass, preferably quartz glass. This allows the corresponding optical fibers to be fixed along their elongated extension to the optical fiber holder of the carrier, whereby mechanical relief (e.g. strain relief and bending protection of the optical fibers) of the connection between the optical fibers and the optical first element can be realized. In this manner, the corresponding optical fibers can also be indirectly connected to the optical first element in a fixed manner along their elongated extension, which can increase the mechanical stability of the optical fibers with respect to the optical first element.

This can be converted for one of the optical fibers, for several of the optical fibers or for all optical fibers, which can increase the design freedom and make the respective properties and advantages described above usable or convert them.

The present invention also relates to a fiber optical component comprising a plurality of optical fibers each having at least, preferably exactly, one core of glass, preferably of quartz glass, which is designed in each case to guide a signal light radiation, with at least, preferably exactly, a first optical element made of glass, preferably quartz glass, per optical fiber, which is connected at an inlet surface to at least, preferably exactly, one open end of a core of one of the optical fibers, preferably further to an open end of a cladding of one of the optical fibers substantially enclosing the core, and is designed to transmit the signal light radiation, and is designed to receive the signal light radiation from the open end of the core of the optical fiber and to emit it to the outside via at least one outlet surface, with at least, preferably exactly, one second optical element made of optical fiber, preferably made of quartz glass, per first optical element, which is designed and arranged along the direction of propagation of the signal light radiation in each case at a distance relative to the respective first optical element or in each case directly on the respective first optical element, to receive the signal light radiation of at least, preferably exactly, one of the optical fibers at an inlet surface from the first optical element and to emit it to the outside via at least one outlet surface, and with a carrier which positions the first optical elements at least, preferably exactly, transversely to the direction of propagation of the signal light radiations relative to one another, wherein the carrier has glass, preferably quartz glass, preferably consists of glass, preferably quartz glass.

This alternative solution to the object underlying the invention thus relates to a plurality of first optical elements each having at least one further, second, optical element. This leads to an alternative connection between the first optical elements, the second optical elements and the carrier. This means that there are several first optical elements which are connected to one another by means of the carrier. The second optical elements can also be connected to the first optical elements by means of the carrier. Alternatively, the second optical elements can each be connected to the respective first optical element, for which purpose the second optical elements can also be designed in one piece, i.e. integrally, with the respective first optical element. This can also include that the first optical elements can be designed to be hollow cylindrical in portions along the direction of propagation of the signal light radiation, such that the first optical elements can be connected to the edge of the respective second optical element and at the same time be spaced apart from the inlet surface of the respective second optical element with respect to their outlet surface.

In the solution described first, only a common first optical element is present and the second optical elements are connected to the first optical element by means of the carrier, wherein the second optical elements can also be connected to one another by means of the carrier.

Accordingly, the corresponding properties and advantages described above can also be converted and used in this case. In particular, this can improve or ensure the positioning of the individual first optical elements, including the respective second optical element, with respect to one another as described above.

In accordance with one aspect of the invention, the carrier has a transverse carrier which positions the first optical elements transverse to the direction of propagation of the signal light beams relative to one another. This means that the corresponding properties and advantages described above can also be converted and used in this case.

In accordance with a further aspect of the invention, the material of the carrier, preferably of the transverse carrier, is welded to the material of the first optical elements, preferably to an additional amount of glass, preferably of fused silica. This means that the corresponding properties and advantages described above can also be converted and used in this case.

In accordance with a further aspect of the invention, the inlet surface of the respective second optical element along the direction of propagation of the signal light beams is in each case directly materially connected, preferably welded, or integrally designed with the outlet surface of the respective first optical element. In this manner, a distance and thus an intermediate space filled by the surrounding medium, such as the ambient air, between the first optical element and the second optical element can be avoided. This can protect the ray path there from external influences.

In accordance with a further aspect of the invention, the inlet surface of the respective second optical element is spaced along the direction of propagation of the signal light beams by means of the carrier, preferably by means of a longitudinal carrier of the carrier, in each case with respect to the outlet surface of the respective first optical element. This can increase the design options.

In accordance with a further aspect of the invention, the first optical elements are arranged at an angle to one another by means of the carrier, preferably by means of a transverse carrier of the carrier, preferably aligned with a common focal point of the signal light beams. This can increase the design options.

In accordance with a further aspect of the invention, the carrier, preferably an optical fiber holder of the carrier, positions the optical fibers facing away from the respective inlet surface of the respective first optical element transversely to the direction of propagation of the signal light beams, loosely guided or fixedly connected. This means that the corresponding properties and advantages described above can also be converted and used in this case.

In accordance with a further aspect of the invention, the second optical elements are each designed as microlenses. By designing the second optical elements as microlenses, which together can also be referred to as a microlens array, the outgoing signal light radiation can be influenced optically, e.g. by collimating the signal light beams. Providing preferably one microlens per optical fiber and directly opposite the optical fiber can make it possible for the signal light radiation of each optical fiber or its core to reach the respective microlens in a straight line through the first optical element and, if necessary, additionally through the material of a transverse carrier of the carrier, such that the microlens can act on precisely the signal light radiation of the optical fiber or its core assigned to it. The microlens is thus aligned with the optical axis of the respective signal light beam.

In accordance with a further aspect of the invention, the fiber optical component further has at least, preferably exactly, a third optical element, preferably a collimator, made of glass, preferably quartz glass, which is designed and arranged along the direction of propagation of the signal light radiations relative to the outlet surfaces of the respective second optical elements in order to receive the signal light radiations at an inlet surface from the respective second optical element and to emit them to the outside via an outlet surface. This means that a further optical element can be arranged along the direction of propagation of the signal light beams or in their ray path in order to further influence the signal light beams.

In any case, all aspects of the German patent application 10 2022 101 915.2 (unpublished) can be combined with the present invention, such that the content of the German patent application 10 2022 101 915.2 is incorporated by reference into the present patent application.

A plurality of exemplary embodiments and further advantages of the invention are illustrated and explained in more detail below, purely schematically, in connection with the following figures. In the drawings:

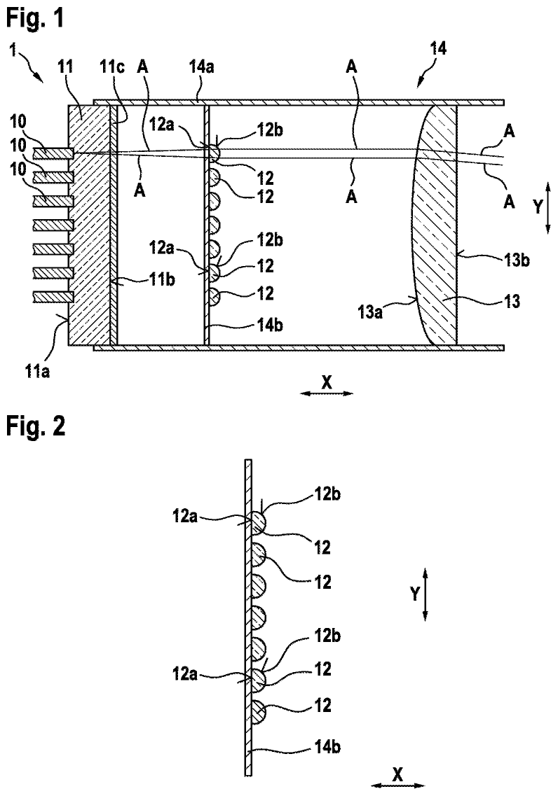

FIG. 1 shows a horizontal section through a fiber optical component according to the invention in accordance with a first exemplary embodiment;

FIG. 2 shows a detailed view of the second optical element of FIG. 1;

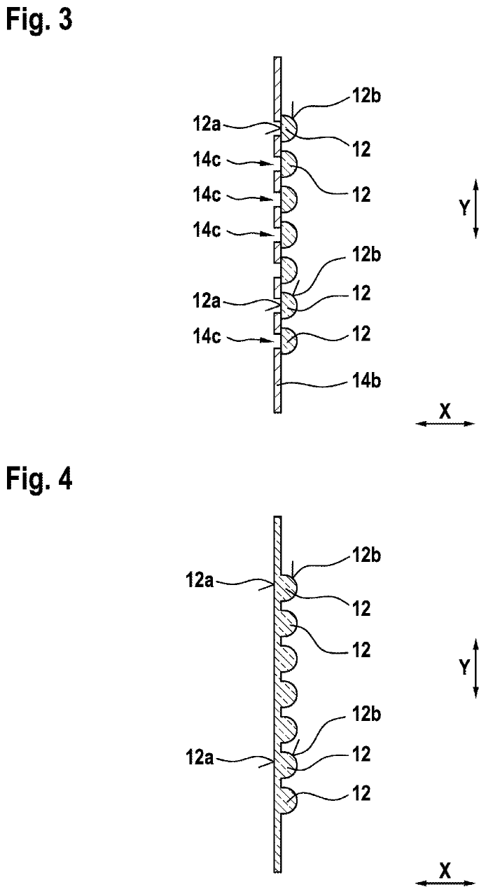

FIG. 3 shows a second variant of the second optical element of FIG. 1 in accordance with a second exemplary embodiment;

FIG. 4 shows a third variant of the second optical element of FIG. 1 in accordance with a third exemplary embodiment;

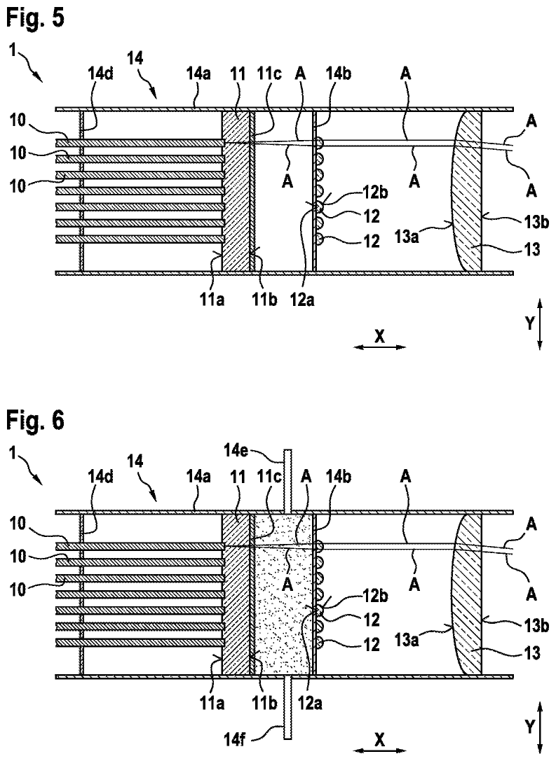

FIG. 5 shows a horizontal section through a fiber optical component according to the invention in accordance with a fourth exemplary embodiment;

FIG. 6 shows a horizontal section through a fiber optical component according to the invention in accordance with a fifth exemplary embodiment;

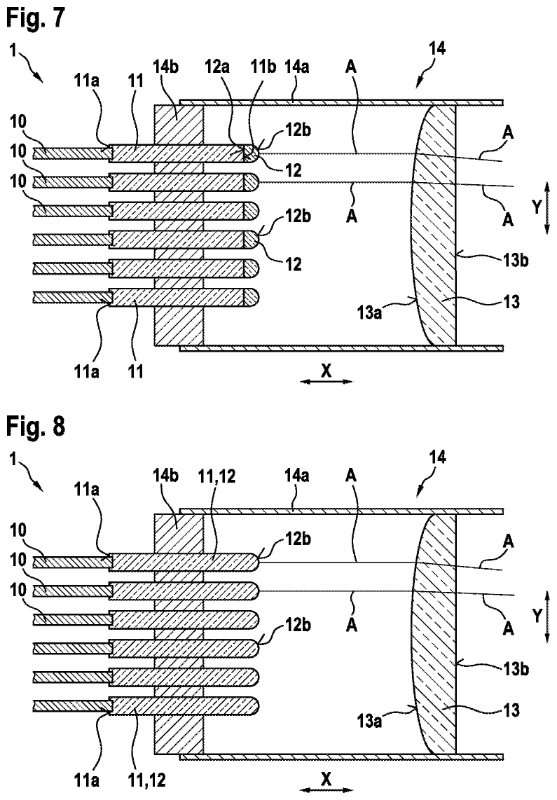

FIG. 7 shows a horizontal section through a fiber optical component according to the invention in accordance with a sixth exemplary embodiment;

FIG. 8 shows a horizontal section through a fiber optical component according to the invention in accordance with a seventh exemplary embodiment;

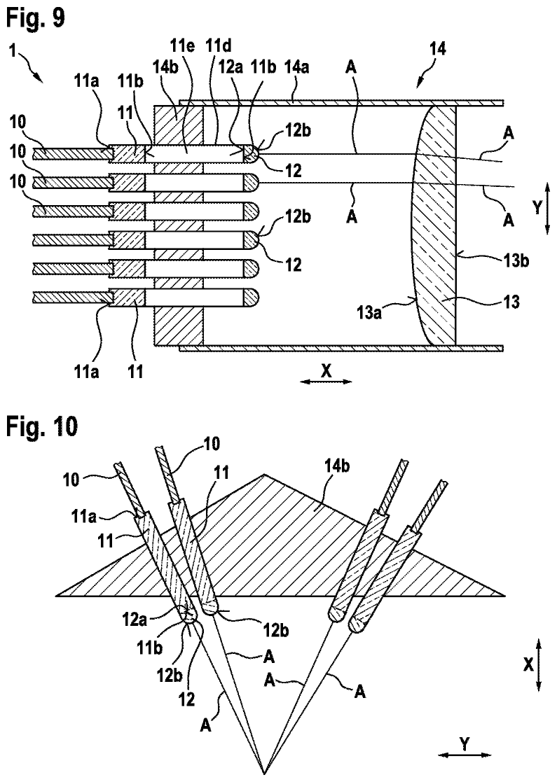

FIG. 9 shows a horizontal section through a fiber optical component according to the invention in accordance with a eighth exemplary embodiment;

FIG. 10 shows a second variant of the first optical elements of FIG. 7 in accordance with a ninth exemplary embodiment;

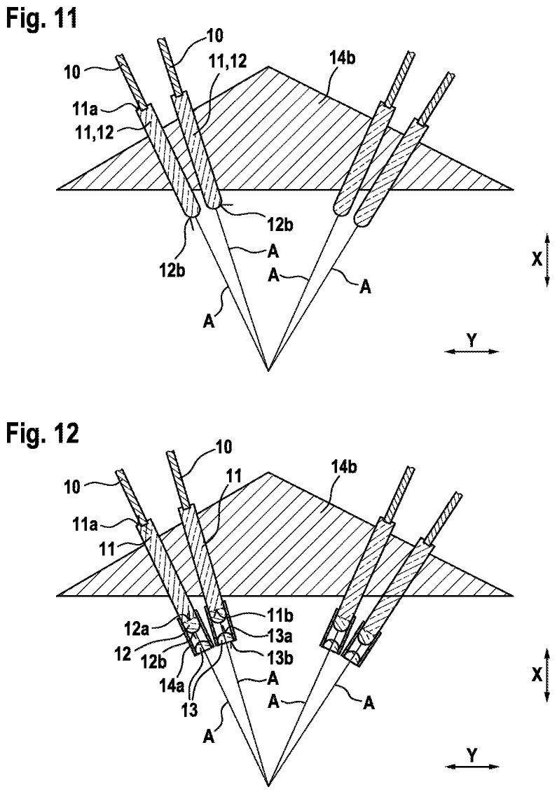

FIG. 11 shows a second variant of the first optical elements of FIG. 8 in accordance with a tenth exemplary embodiment; and

FIG. 12 shows a third variant of the first optical elements of FIG. 7 in accordance with an eleventh exemplary embodiment.

The above figures are viewed in Cartesian coordinates. It extends in a longitudinal direction X, which can also be referred to as depth X or length X. A transverse direction Y, which can also be referred to as width Y, extends perpendicular to the longitudinal direction X. Perpendicular to both the longitudinal direction X and the transverse direction Y is a vertical direction (not shown), which can also be referred to as height and corresponds to the direction of gravity. The longitudinal direction X and the transverse direction Y together form the horizontal line X, Y, which can also be referred to as the horizontal plane X, Y.

FIG. 1 shows a horizontal section through a fiber optical component 1 according to the invention in accordance with a first exemplary embodiment. The fiber optical component 1 has a plurality of optical fibers 10, each of which has a core (not shown) which is cylindrically enclosed by a cladding (not shown) and the cladding is cylindrically enclosed by a coating (not shown). The cross-sections and contours of the cores, cladding and coatings are circular. In their elongated direction of extension, the optical fibers 10 end at a common equal height in the longitudinal direction X, each with an open end (not designated). The cores and claddings of the optical fibers 10 extend the same distance and end together at the respective open end. The coatings are each spaced apart in the vertical direction Z at the same height from the open ends of the optical fibers 10 (not shown), such that the open ends of the optical fibers 10 are exposed from the coatings.

The fiber optical component 1 also has a first optical element 11, which may also be referred to as a fiber outlet element 11, a signal light radiation outlet 11, an optical window 11, an optical lens 11, an optical beam splitter 11 or an optical prism 11, or is formed by these. An optical base body of the first optical element 11 in the form of a glass body is designed in the shape of a cuboid with edge lengths in the area of 5 mm to 80 mm, for example, and has an inlet surface 11a pointing to the left in the longitudinal direction X and an outlet surface 11b pointing to the right on the opposite side. The four sides of the cuboid optical element 11 are formed by the side surfaces (not shown or not labeled). An optical coating 11c in the form of an anti-reflection coating 11c is applied over the entire surface of the outlet surface 11b of the first optical element 11, which can be attributed to the first optical element 11.

The open ends of the cores and claddings of the optical fibers 10 are arranged with a penetration depth (not indicated) relative to the inlet surface 11a of the first optical element 11 within the material of the first optical element 11. The materials of the cores and claddings of the optical fibers 10 have been fused with the material of the first optical element 10 for this purpose. This can ensure that signal light beams A, for example in the form of laser light beams A, can be introduced into the first optical element 11 as completely and without interference as possible. The signal light radiations A introduced into the first optical element 11 can pass through it and emerge outwards as outlet radiations A via the outlet surface 11b of the first optical element 11. This can also improve the mechanical stability of the material-locking connection between the optical fibers 10 and the first optical element 11.

The fiber optical component 1 further has a plurality of second optical elements 12, which are formed by microlenses 12 that functionally together form a microlens array 12. Each second optical element 12 has an inlet surface 12a, which faces the outlet surface 11b of the first optical element 11 along the longitudinal direction X and is spaced apart from the latter. Opposite, each second optical element 12 has an outlet surface 12b. The inlet surface 12a of the second optical element 12 and/or the outlet surface 12b of the second optical element 12 may also have an anti-reflection coating as described with respect to the outlet surface 11b of the first optical element 11. Exactly one second optical element 12 is provided for each optical fiber 10 and is arranged along the longitudinal direction X as the substantially propagation direction of the signal light radiation A in such a manner that the signal light radiation A of each optical fiber 10 emerging from the outlet surface 11b of the first optical element 11 is picked up by the respective second optical element 12 at its inlet surface 12a and, due to the design of the second optical elements 12 as microlenses 12, emerges at its outlet surface 12b extending in parallel.

In order now to position and hold the second optical elements 12 relative to one another in the transverse direction Y, i.e. transversely to the direction of propagation of the signal light radiations A, and the entirety of the second optical elements 12 as a microlens array 12 in the longitudinal direction X, i.e. in the direction of propagation of the signal light beams A, relative to the first optical element 11, the fiber optical component 1 has a carrier 14, which can also be referred to as a frame 14, a rack 14 or also, particularly when substantially to completely closed, as a housing 14. The carrier 14 may also have an anti-reflective coating as described with respect to the outlet surface 11b of the first optical element 11. In accordance with the first exemplary embodiment of FIG. 1, the carrier 14 has a longitudinal carrier 14a which extends in the longitudinal direction X and surrounds or encloses the other elements of the fiber optical component 1 in the longitudinal direction X and in the vertical direction. The carrier 14 further has a transverse carrier 14b, which is arranged in the transverse direction Y between the inner surfaces (not designated) of the longitudinal carrier 14a.

According to the invention, the carrier 14 or the longitudinal carrier 14a and transverse carrier 14b thereof, as well as the cores of the optical fibers 10, which are fused to the first optical element 11, the first optical element 11 and the second optical element 12 are designed from glass and particularly from quartz glass. As a result, the carrier 14 or the longitudinal carrier 14a and transverse carrier 14b thereof can have the same optical and thermal behavior as the optical fibers 10, the first optical element 11 and the second optical element 12 of the fiber optical component 1. Thus, the absorption of signal light radiation A by the carrier 14 or the longitudinal carrier 14a and transverse carrier 14b thereof can be kept low, since glass or transverse glass absorbs comparatively little radiation, relative to the metallic carriers 14 used to date. Due to the comparatively low absorption of signal light radiation A, any resulting heat-induced expansion of the material of the carrier 14 or the longitudinal carrier 14a and transverse carrier 14b thereof can be kept to a minimum, which can favor the accuracy of the positioning of the first optical element 11 and the second optical elements 12 relative to one another. This also applies to heating of the carrier 14 or the longitudinal carrier 14a and transverse carrier 14b, which can be caused by other external influences.

For these reasons, additional material in the form of glass or quartz glass is applied at the connection points between the first optical element 11 and carrier 14 and between the second optical element 12 and carrier 14 and is used to fuse or splice the connection partners in order to utilize the properties and advantages described above at the connection points as well.

For this reason, the optical fibers 10, the first optical element 11 and the second optical element 12 also have the same glass material and particularly the same quartz glass material in order to avoid differences in the absorption behavior and in the thermal behavior or in the thermally induced expansion of the optical fibers 10, the first optical element 11, the second optical element 12 and the carrier 14. This also applies to the material of the joints.

A third optical element 13 in the form of a collimator 13, an optical lens 13 or a protective window 13 is held by the carrier 14 or the longitudinal carrier 14a thereof along the longitudinal direction X in the further course of the signal light beams A as described above. The signal light beams A enter the third optical element 13 along the longitudinal direction X through a convex inlet surface 13a and exit again into the environment through its flat outlet surface 13b. This can further influence the signal light beams A.

A volume is completely enclosed by the first optical element 11 together with part of the carrier 14, which can be filled with ambient air, but also with another medium such as an inert gas, in order to influence the propagation behavior of the signal light beams A. This applies accordingly to the volume enclosed by the second optical element 12, another part of the carrier 14 and the third optical element 13.

In accordance with the first exemplary embodiment of FIGS. 1 and 2, the individual second optical elements 12 are arranged as microlenses 12 on the side of the transverse carrier 14b facing away from the first optical element 11 by welding, such that the signal light beams A penetrate the material of the transverse carrier 14b and then reach the respective second optical element 12 through the respective inlet surface 12a. This can be a comparatively simple option for conversion.

FIG. 3 shows a second variant of the second optical element 12 of FIG. 1 in accordance with a second exemplary embodiment. In this case, the transverse carrier 14b has one through-opening 14c per second optical element 12, through which the signal light beams A pass in each case and can reach the respective inlet surface 12a of the respective second optical element 12 directly. In this manner, interference of the signal light beams A by the material of the transverse carrier 14b can be avoided, although this may increase the manufacturing effort.

FIG. 4 shows a third variant of the second optical element 12 of FIG. 1 in accordance with a third exemplary embodiment. In this case, the transverse carrier 14b is dispensed with in that the second optical elements 12 are designed in one piece, i.e. integrally, as a microlens array 12, which extends in the transverse direction Y to the inner surfaces of the longitudinal carrier 14a and is welded there to the longitudinal carrier 14a as described above. This means that the transverse carrier 14b can be dispensed with. This can also simplify the production of the microlens array 12.

FIG. 5 shows a horizontal section through a fiber optical component 1 according to the invention in accordance with a fourth exemplary embodiment. The fiber optical component 1 according to the fourth exemplary embodiment corresponds to the fiber optical component 1 in accordance with the first exemplary embodiment of FIGS. 1 and 2, with the addition that the carrier 14 or the longitudinal carrier 14a thereof is further extended in the longitudinal direction X pointing away from the first optical element 11 and the carrier 14 there has a fiber optic holder 14d extending in the transverse direction Y. The optical fiber holder 14d has a through-opening (not shown) for each optical fiber 10, through which the respective optical fiber 10 extends and to which the respective optical fiber 10 or the cladding thereof is fused by means of additional glass material or quartz glass material. This can improve the hold of the optical fibers 10 relative to the first optical element 11.

FIG. 6 shows a horizontal section through a fiber optical component 1 according to the invention in accordance with a fifth exemplary embodiment. The fiber optical component 1 in accordance with the fifth exemplary embodiment corresponds to the fiber optical component 1 in accordance with the fourth exemplary embodiment, with the addition that the volume, which is enclosed in a fluid-tight manner by the first optical element 11 and the carrier 14 or the parallel longitudinal carriers 14a and transverse carriers 14b thereof, is accessible by means of an inlet 14e in order to receive a flowing means such as a flowing fluid such as a coolant, for example, which can exit the volume again through an outlet 14f. Alternatively, the medium could be permanently provided as a filling in a closed volume, i.e. the volume can be filled with the medium and then closed media-tight.

FIG. 7 shows a horizontal section through a fiber optical component 1 according to the invention in accordance with a sixth exemplary embodiment. In this case, each optical fiber 10 has a single first optical element 11 to which the optical fibers 10 are each fused as described with respect to the first exemplary embodiment of FIGS. 1 and 2. Further, the individual second optical elements 12 per optical fiber 10 are connected to the respective first optical element 11, which is done by fusing the outlet surfaces 11b of the respective first optical element 11 to the inlet surface 12a of the respective second optical element 12. The signal light beams A thus pass from the optical fiber 10 into the first optical element 11 and from there directly into the second optical element 12 in order to then leave the second optical element 12 via its outlet surface 12b.

In this case, the carrier 14 has a transverse carrier 14b, which connects the individual first optical elements 11 together with the second optical elements 12 arranged there and positions them relative to one another. For this purpose, the carrier 14 or the transverse carrier 14b thereof is also designed from glass or quartz glass as described above. A third optical element 13, which is also additionally present here, can be connected to the transverse carrier 14b and thus to the first optical elements 11 by means of a longitudinal carrier 14a, as described above.

FIG. 8 shows a horizontal section through a fiber optical component 1 according to the invention in accordance with a seventh exemplary embodiment. In this case, the first optical elements 11 and the second optical elements 12 are each designed in one piece, i.e. integrally, per optical fiber 10. The outlet surfaces 12b of the second optical elements 12 may have been machined out of the material of the respective optical element 11, 12 by grinding or similar.

FIG. 9 shows a horizontal section through a fiber optical component 1 according to the invention in accordance with an eighth exemplary embodiment. In this case, the first optical element 11 is designed substantially hollow-cylindrical, such that each individual first optical element 11 is connected or fused to the respective optical fiber 10 as described above, but the first optical element 11 then extends further along the extension direction of the signal light beams A hollow-cylindrical, quasi like a capillary. Each first optical element 11 is connected to the exterior side of the hollow cylindrical area 11d with the transverse carrier 14b, as previously described. At the open end of the respective hollow cylindrical area 11 of each first optical element 11, the first optical element 11 is connected to the inlet surface 12a of a second optical element 12, as described above.

Accordingly, the signal light beams A can enter the respective hollow cylindrical area 11d of each first optical element 11 via the respective outlet surface 11b of the respective first optical element 11 into the closed inner volume 11e thereof, which is usually filled with air or inert gas. From the respective hollow cylindrical area 11d of each first optical element 11, the signal light beams A can then enter the second optical elements 12 via the respective inlet surface 12a of the latter. From there, the propagation of the signal light beams A can continue as described above.

FIG. 10 shows a second variant of the first optical elements 11 of FIG. 7 in accordance with a ninth exemplary embodiment. In this case, the third optical element 13 is dispensed with and the transverse carrier 14b is designed to be triangular, such that the first elements 11 are aligned at an angle to one another to a common focal point of the signal light beams A. This can increase the design options.

FIG. 11 shows a second variant of the first optical elements 11 of FIG. 8 in accordance with a tenth exemplary embodiment. In this case, the first optical elements 11 and the second optical elements 12 of the ninth exemplary embodiment of FIG. 10 are designed in one piece, as in the seventh exemplary embodiment of FIG. 8.

FIG. 12 shows a third variant of the first optical elements 11 of FIG. 7 in accordance with an eleventh exemplary embodiment. In this case, in addition to the sixth exemplary embodiment of FIG. 7, a third optical element 13 is provided for each first optical element 11 as a collimator 13, which is held in each case by a longitudinal carrier 14a at the end (not designated) of the respective first optical element 11. This can also enable the use of collimators 13 in this case.

### REFERENCE LIST (PART OF THE DESCRIPTION)

A signal light radiations; laser light radiations; outlet radiations
X longitudinal direction; depth; length
Y transverse direction; width
X, Y horizontal line; horizontal plane
1 fiber optical component
10 optical fibers
11 first optical element; fiber outlet element; signal light radiation output;
optical window; optical lens; optical beam splitter; optical prism
11a inlet surface of the first optical element 11
11b outlet surface of the first optical element 11
11c optical coating or anti-reflection coating of the outlet surface 11b of the
first optical element 11
11d hollow cylindrical area of the first optical element 11
11e inner volume of the first optical element 11
12 second optical element, microlenses; microlens array
12a inlet surface of the second optical element 12
12b outlet surface of the second optical element 12
13 third optical element; collimator; optical lens; protective window
13a inlet surface of the third optical element 13
13b outlet surface of the third optical element 13
14 carrier; frame; rack; housing
14a longitudinal carrier of the carrier 14
14b transverse carrier of the carrier 14
14c through-openings of the transverse carrier 14b of the carrier 14
14d optical fiber holder of the carrier 14
14e inlet of the carrier 14
14f outlet of the carrier 14

1. A fiber optical component
having a plurality of optical fibers each having at least one core of glass, preferably of quartz glass, which is designed in each case to guide a signal light radiation,
having at least one first optical element made of glass, preferably quartz glass, which is connected at an inlet surface to a respective open end of the cores of the optical fibers, preferably further to an open end of a cladding of the optical fibers substantially enclosing the core, and is designed to receive the signal light radiations from the open ends of the cores of the optical fibers and to emit them to the outside via at least one outlet surface,
having at least one second optical element of glass, preferably of quartz glass, per optical fiber, which is designed and arranged at a distance relative to the first optical element along the direction of propagation of the signal light radiations in each case, in order to receive the signal light radiation of at least one of the optical fibers at an inlet surface of the first optical element and to emit it to the outside via at least one outlet surface, and
having a carrier which positions the second optical elements at least along the direction of propagation of the signal light beams, preferably and transversely to the direction of propagation of the signal light beams, relative to the first optical element,
wherein the carrier has glass, preferably quartz glass, preferably consists of glass, preferably quartz glass.

2. The fiber optical component according to claim 1,
wherein the carrier has a longitudinal carrier which positions the second optical elements relative to the first optical element along the direction of propagation of the signal light beams, and/or
wherein the carrier has a transverse carrier which positions the second optical elements relative to the first optical element transversely to the direction of propagation of the signal light beams.

3. The fiber optical component according to claim 1,
wherein the material of the carrier, preferably the longitudinal carrier and/or the transverse carrier, is welded to the material of the second optical elements, preferably with an additional amount of glass, preferably of quartz glass.

4. The fiber optical component according to claim 1,
wherein the carrier, preferably a transverse carrier of the carrier, receives the second optical elements facing away from the first optical element in such a manner that the signal light radiations penetrate the material of the carrier, preferably of the transverse carrier.

5. The fiber optical component according to claim 1,
wherein the carrier, preferably a transverse carrier of the carrier, has one through-opening per second optical element and
wherein the carrier, preferably the transverse carrier, receives the second optical elements facing away from the first optical element in such a manner that the signal light radiations pass through the respective through-opening of the carrier, preferably of the transverse carrier.

6. The fiber optical component according to claim 1,
wherein the second optical elements are designed in one piece or in one piece and the signal light radiations penetrate the material of the one-piece or one-piece second optical elements directly.

7. The fiber optical component according to claim 1,
wherein the outlet surface of the first optical element, the inlet surface of the second optical element, the outlet surface of the second optical element and/or the carrier has an optical coating preferably an optical anti-reflection coating, at least in sections, preferably over the entire surface.

8. The fiber optical component according to claim 1,
wherein the carrier, preferably an optical fiber holder of the carrier, positions the optical fibers facing away from the inlet surface of the first optical element transversely to the direction of propagation of the signal light beams, loosely guided or fixedly connected.

9. A fiber optical component
having a plurality of optical fibers each having at least one core of glass, preferably of quartz glass, which is designed in each case to guide a signal light radiation,
having at least one first optical element of glass, preferably of quartz glass, per optical fiber, which is connected at an inlet surface to at least one open end of a core of one of the optical fibers, preferably further with an open end of a cladding of one of the optical fibers substantially enclosing the core, and is designed to receive the signal light radiation from the open end of the core of the optical fiber and to emit it to the outside via at least one outlet surface,
having at least one second optical element of glass, preferably of quartz glass, per first optical element, which is designed and arranged along the direction of propagation of the signal light radiations in each case at a distance relative to the respective first optical element or in each case directly on the respective first optical element, in order to receive the signal light radiation of at least one of the optical fibers at an inlet surface of the first optical element and to emit it to the outside via at least one outlet surface, and
having a carrier which positions the first optical elements transversely to the direction of propagation of the signal light beams relative to one another,
wherein the carrier has glass, preferably quartz glass, preferably consists of glass, preferably quartz glass.

10. The fiber optical component according to claim 9,
wherein the carrier has a transverse carrier which positions the first optical elements transversely to the direction of propagation of the signal light beams relative to one another.

11. The fiber optical component according to claim 9,
wherein the material of the carrier, preferably of the transverse carrier, is welded to the material of the first optical elements, preferably with an additional amount of glass, preferably of quartz glass.

12. The fiber optical component according to claim 9,
wherein the inlet surface of the respective second optical element is directly connected, preferably welded, or designed in one piece with the outlet surface of the respective first optical element along the direction of propagation of the signal light beams.

13. The fiber optical component according to claim 9,
wherein the inlet surface of the respective second optical element is spaced along the direction of propagation of the signal light beams by means of the carrier, preferably by means of a longitudinal carrier of the carrier, in each case with respect to the outlet surface of the respective first optical element.

14. The fiber optical component according to claim 9,
wherein the first optical elements are arranged by means of the carrier, preferably by means of a transverse carrier of the carrier, at an angle to one another, preferably aligned with a common focal point of the signal light beams.

15. The fiber optical component according to claim 9,
wherein the carrier, preferably an optical fiber holder of the carrier, positions the optical fibers facing away from the respective inlet surface of the respective first optical element transversely to the direction of propagation of the signal light beams, loosely guided or fixedly connected.

16. The fiber optical component according to claim 1,
wherein the second optical elements are each designed as microlenses.

17. The fiber optical component according to claim 1,
further comprising at least, preferably exactly, a third optical element, preferably a collimator, of glass, preferably of quartz glass, which is designed and arranged along the direction of propagation of the signal light radiations relative to the outlet surfaces of the respective second optical elements in order to receive the signal light radiations at an inlet surface of the respective second optical element and to emit them to the outside via an outlet surface.

18. The fiber optical component according to claim 9,
wherein the second optical elements are each designed as microlenses.

19. The fiber optical component according to claim 9,
further comprising at least, preferably exactly, a third optical element, preferably a collimator, of glass, preferably of quartz glass, which is designed and arranged along the direction of propagation of the signal light radiations relative to the outlet surfaces of the respective second optical elements in order to receive the signal light radiations at an inlet surface of the respective second optical element and to emit them to the outside via an outlet surface.
